(19) United States
(12) Patent Application Publication
(10) Pub. No.: US 2003/0216947 A1
(43) Pub. Date: Nov. 20, 2003

(54) Pricing employee termination benefits

(76) Inventors: Brock W. Callen, Chilmark, MA (US); Hope C. Callen, Chilmark, MA (US)

Correspondence Address: FISH & RICHARDSON PC, 225 FRANKLIN ST, BOSTON, MA, 02110, US

(21) Appl. No.: 10/152,050

(22) Filed: May 20, 2002

(51) Int. Cl. G06F 17/60

(52) U.S. Cl. 705/4; 705/40

(57) ABSTRACT

Prices for coverages of termination benefits are aggregated with respect to cells of employees who are selected, based on employment demographics, to reduce the impact of adverse selection by an employer of the employees. The price for each of the cells includes an enhanced component that represents an excess over the anticipated termination rate of that cell. The excess termination rate is a predetermined multiple of the anticipated termination rate for at least some cells for which the anticipated termination rates are different.

### BACKGROUND

This description relates to pricing employee termination benefits.

One common way to control such benefits is through a private arrangement between an employer and each displaced employee, for example, a standard severance policy or a special termination package. Typical arrangements provide for a single payment on the date of termination. The amount of the termination payment is often based on the terminated employee's salary level and tenure. Outplacement services are sometimes offered.

Government sponsored unemployment insurance programs also typically pay benefits for a fixed number of weeks and usually are funded by premiums imposed on employers.

Short and long-term disability insurance, funded by premiums, pays benefits when an employee is unable to work because of illness or injury.

An employee can also privately obtain coverage that continues payment of credit obligations for a brief period during unemployment.

Non-voluntary job changes are common. The causes include “downsizing”, “rightsizing”, mergers and acquisitions, product line changes, technology advances, expanding global markets, and geographic redistribution of work force.

Although time between jobs tends to be limited for anyone who actively seeks a new job, it can be longer than is provided for in typical severance packages. The “fixed” monthly living costs incurred by moderate and high income employees, such as mortgage, credit card debt, tuition, car and insurance payments, tend to be large. An interruption in an employee's income stream after termination from one job and before the start of another one can cause disruption in life style and jeopardize his credit rating and therefore be a significant concern to him.

Many employers incur large costs, which may negatively impact cash flow and earnings, for non-voluntary terminations of their employees. The annual costs of non-voluntary terminations may vary and in an occasional year be sharply higher than normal.

It has been known to deliver termination benefits that are not subject to withholding for FICA, FUTA, SUI, or Medicare by using the vehicle of a supplemental unemployment benefit (SUB) plan under section 501(c)(17) of the United States federal tax law.

### SUMMARY

In general, in one aspect, the invention features a method that includes aggregating prices for coverages of termination benefits with respect to cells of employees who are selected, based on employment demographics, to reduce the impact of adverse selection by an employer of the employees. The price for each of the cells includes an enhanced component that represents an excess over the anticipated termination rate of that cell. The excess termination rate is a predetermined multiple of the anticipated termination rate for at least some cells for which the anticipated termination rates are different.

Implementations of the invention may include one or more of the following features. The employment demographics are at least one of the employees' salaries, length of service, and job classification. The anticipated termination rate is based on an historical displacement rate. The multiple is selected by the employer. The predetermined multiple is used to determine the excess termination rate, if any, with respect to all of the cells. The price for each of the cells includes a base component that represents an anticipated termination rate of employees in the cell, and the base component and the enhanced component reflect different durational risks. The excess termination rate represents coverages that are to be available for termination benefits in a single year.

In general, in another aspect, the invention features a method that includes receiving from an employer a designation of a predetermined multiple value associated with pricing of coverage for termination benefits for employees of the employer in excess of base benefits that are based on anticipated termination rates, and providing coverage for termination benefits in each of at least some cells of employees up to a rate that is the predetermined multiple value times the anticipated termination rate for the cell. The cells comprise groups of employees selected, based on employment demographics, to reduce the impact of adverse selection by an employer of the employees.

Implementations of the invention may include one or more of the following features. The employment demographics comprise at least one of the employees' salaries, length of service, and job classification. The anticipated termination rate is based on an historical displacement rate. The predetermined multiple value is used to determine the excess termination rate with respect to all of the cells.

In general, in another aspect, the invention features, a method that includes (a) paying termination benefits to employees who belong to cells based on employment demographics, the termination benefits for employees in each of the cells being limited to a number of employees that represents an historical displacement rate for that cell plus a predetermined multiple of the historical displacement, and (b) declining payment of further termination benefits for at least some of the cells when the paid termination benefits reach the level specified in (a).

Other advantages and features will become apparent from the following description and from the claims.

### DESCRIPTION

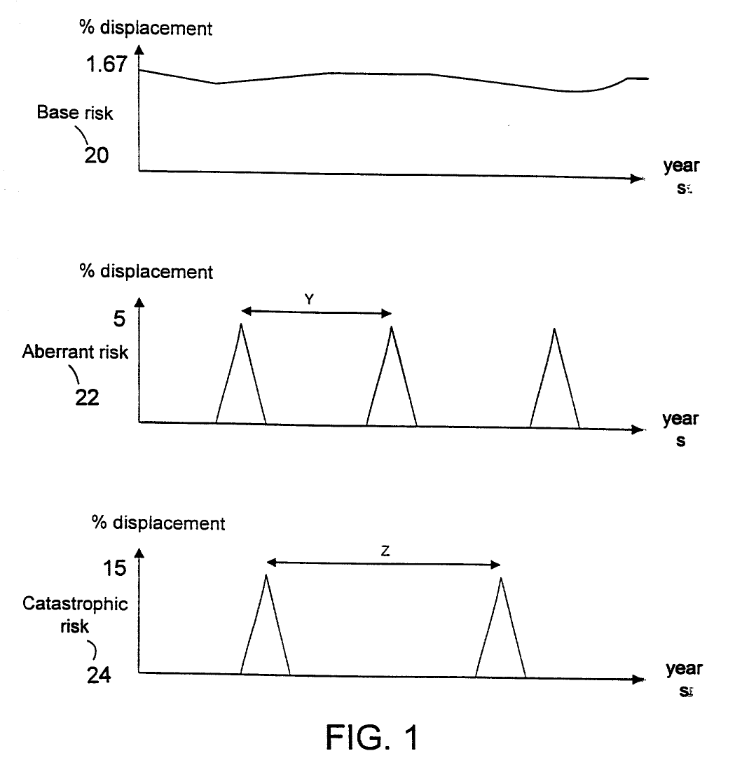

FIG. 1 illustrates an analysis of risk.

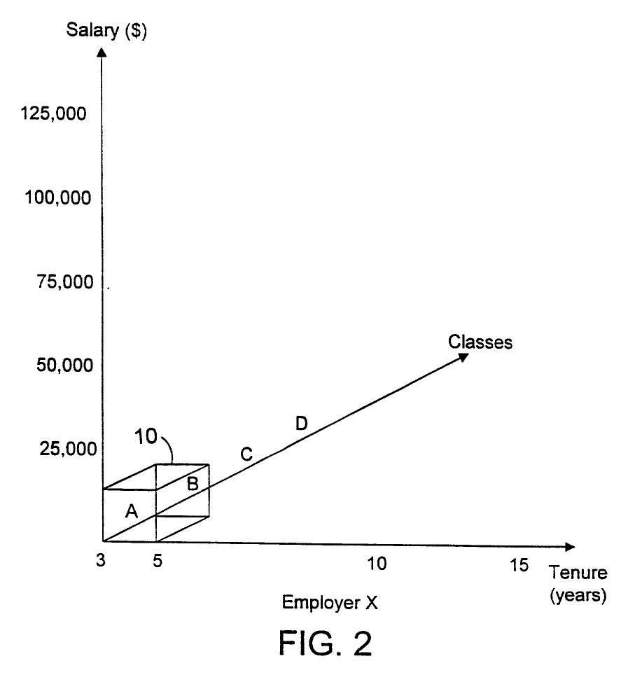

FIG. 2 illustrates employee cells.

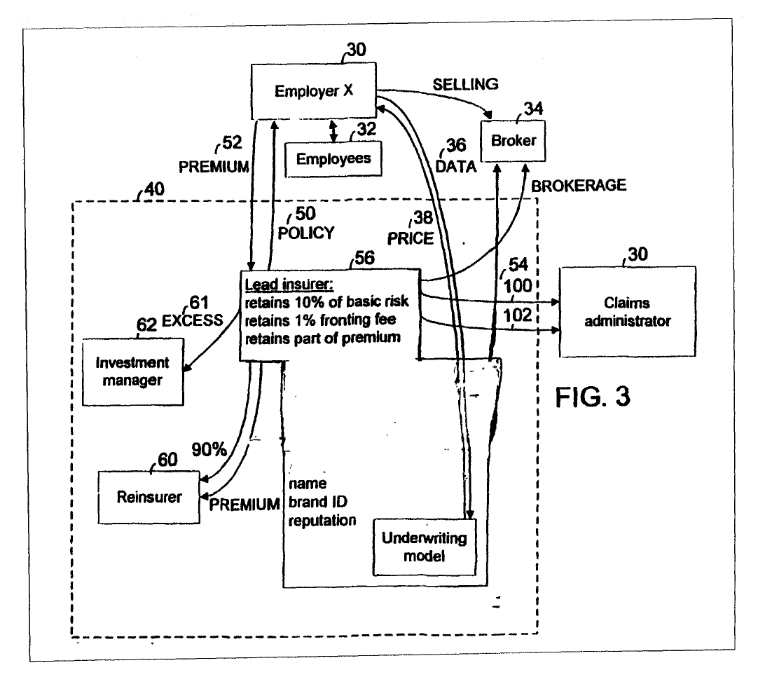

FIG. 3 is a block diagram of parties to and processes of underwriting.

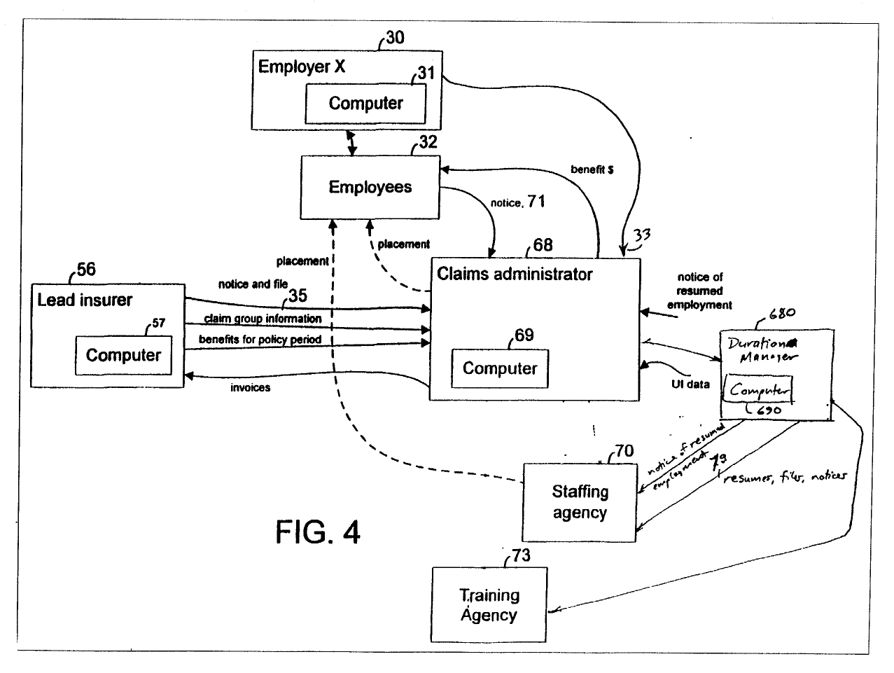

FIG. 4 is a block diagram of parties to and processes of claim administration.

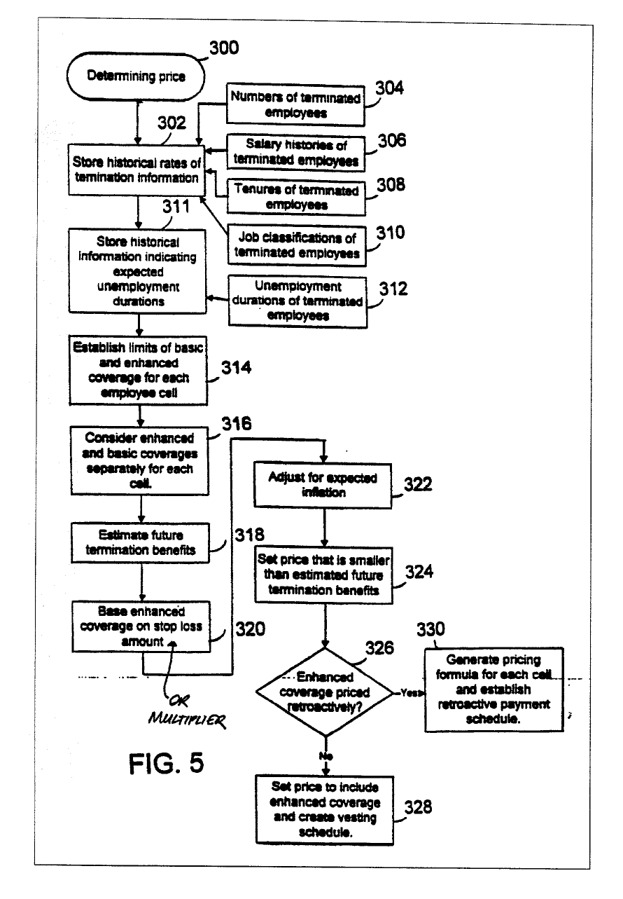

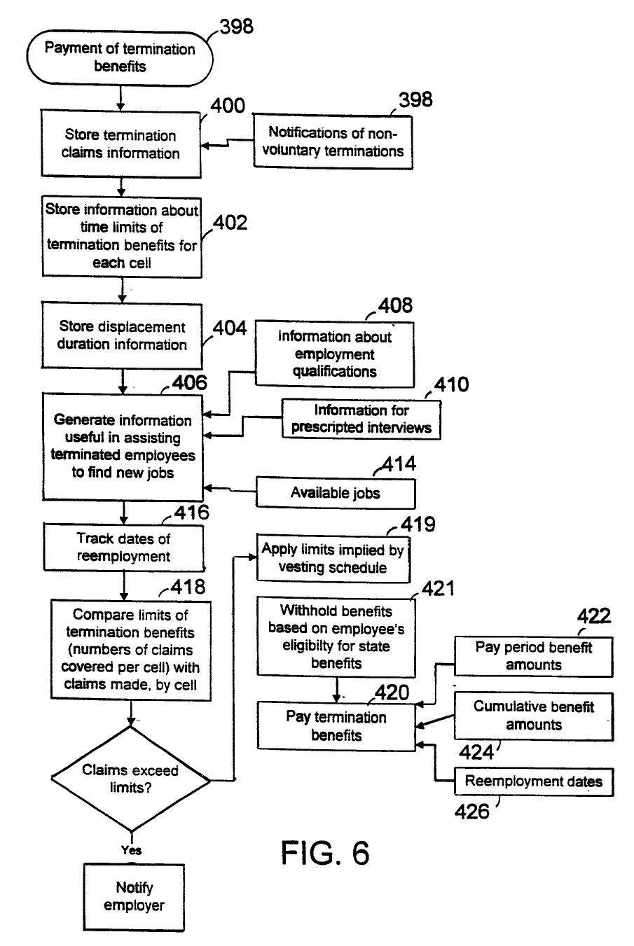

FIGS. 5, 6, and 7 are flow charts.

A concern of insurers (underwriters) with respect to any insurance product is so-called adverse selection. If buyers of the insurance can manipulate the nature or timing of events that trigger coverage under the insurance, the insurer runs an intolerable risk that buyers will take advantage of that possibility. Certain kinds of insurance have not been offered because of such adverse risk concerns.

Employment termination insurance, for example, has been viewed as carrying such an adverse selection risk if the premium is based on some calculated rate of terminations of all employees, e.g., an average historical termination experience for all employees of the employer.

Employers often plan and are in control of the nature and timing of major termination occurrences. They could buy such insurance with the intention of receiving coverage payments for a planned major termination event while paying a relatively small premium based on an assumed rate of terminations that reflects the employer's historical experience. Employers would also be able to plan in advance and control termination occurrences that are not extraordinary in terms of the number of people being terminated, but are extraordinary in terms of salaries.

The effect of adverse selection can be reduced enough to yield a viable insurance product by changing the way in which the risks are isolated, the premiums are calculated, and the benefits paid. One way to reduce the adverse selection risk is to divide the coverage into a base coverage and an enhanced coverage, and price the base and enhanced coverages in different ways. Segmenting the employees of an employer into cells by tenure, salary, and class also provides risk isolation. The coverage then is priced separately for each cell based on the historical termination experience for that cell. Coverage limits are applied to each cell separately.

As seen in FIG. 1, historical non-voluntary termination information for a wide range of employers shows three categories of insurance risk. The same analysis also applies to the employee pool of an individual employer, and to employee cells within the employee pool of a given employer.

A base risk 20 is associated with normal non-voluntary terminations that occur continually in the ordinary course of business for any established/mature employer. This base risk varies little over many years and typically represents terminations approximately equivalent to a specific percentage per year of the total employer's qualifying work force. The percentage would be, for example, about 1.67% for one target market comprised of workers between the ages of 25 and 54 of both sexes of all ethnicities who fall into a white-collar, professional, or Because the variability is small, this risk can be accurately quantified as the average annual non-causal terminations experienced by the employer during an historical five-year period. The historical rate of terminations can be referred to as historical displacement rate (or HDR).

An aberrant risk 22 is associated with occasional short-lived “spikes” with moderately higher terminations than for the base risk. These could be associated, for example, with a termination scenario that involves a plant closing, a contract termination, a workforce consolidation, or a sale of an affiliate. The aberrant risks typically occur periodically with a period of Y years (e.g., Y=3, 4, or 5 years) and may involve, e.g., 2.5% to 5% terminations per year.

A catastrophic risk 24 may occur periodically with a period Z (e.g., Z=5, 7, or 10 years) that is longer than period Y. The termination rate could be as much as 10% to 15% per episode. Examples of catastrophic termination are a corporate restructuring, workforce realignment, or competitive or technological pressures. A catastrophic termination event caused by a Chapter 7 or Chapter 11 filing may be an excluded event.

In a year in which an aberrant episode occurs, the 2.5% to 5% termination includes (is not in addition to) the normal 1.67% that would be expected for that year.

The base risk can be insured in a way that is largely insulated from adverse selection because its variability tends to be small and is inherent in the relationship between the employer and employee, especially given the pressures of technology, deregulation, and a global economic marketplace. Aberrant and catastrophic risks are subject to adverse selection because they are more highly variable and controllable by an employer.

A non-voluntary termination insurance policy for an employer may provide base coverage for the base risk and enhanced coverage for at least part of the aberrant and catastrophic risks. The premium that is charged for the coverage and the limits on the coverage are determined separately for each of the employee cells of the employer.

As seen in FIG. 2, each employee cell 10 may be diagrammed (three dimensionally) based on the range of salaries, job classes (e.g., secretary, senior manager, labeled A, B, C, D), and range of tenure in years (e.g., 0-5 years) to which its members belong. (In one example, an employee would be required to have three years of tenure to be vested and qualified for coverage. However other minimum tenure elections may be made by the employer.)

The coverages provided by the insurance are defined in the policy. Before the insurance contract is signed, the employer specifies the amount and duration of benefits to be paid to qualifying employees in each cell who are terminated unilaterally by the employer for non-causal reasons. The employer may use a formula to specify the termination benefits, for example, a formula that specifies a number of weeks of benefits for each year of service. The value of the weekly termination benefit may be set at a percentage (e.g., 100%) of pre-termination weekly salary chosen by the employer at the time the insurance is bought.

The policy sets a maximum limit on the number of employees in each cell for whom base coverage will apply. The maximum is based on a moving five-year historical average base risk experience for terminations of that cell. For example, if the cell described above had an historical annual average termination rate of 1.67% (HDR), the policy would provide termination benefits for as many as, but no more than, 1.67% of the employees in that cell during the first year of the policy. At the end of the first year, and each subsequent year, the historical average percentage is recomputed rated on the previous five years (and in that sense is a running average). In determining the average, if any of the previous five years has a rate that is more than 10% higher than the running average (e.g., 10% in one year when the running average is 1.67%) that percentage is reduced to 1.1 in the running average (1.1×1.67, in the example) and the running average is recomputed.

The policy also may set a maximum limit on the number of employees in each cell for whom (enhanced) coverage will apply. In one approach, the maximum is based on a stop loss percentage selected by the employer, (e.g., 5% or 15%). The stop loss percentage is conceptually attributable to aberrant and catastrophic risks but is not necessarily the same as any historically determined percentage. If the chosen stop loss percentage is 5% in our example, the extended coverage of the policy would provide termination benefits for 3.33% (5% minus the 1.67% already covered by base coverage) of the employees in that cell each year.

However, in one implementation approach, the maximum termination benefits for extended coverage are not fully available in the first year of the policy.

Rather they are phased in (vested) over several years. For example, in the first year, only 20% of the 3.33% would vest. So in the first year, the maximum benefit under extended coverage for the cell would be 0.66% of the number of employees in that cell. The reason for requiring vesting is to reduce the risk of adverse selection by preventing an employer from reaping the full coverage for a planned aberrant episode in, for example, the first year after buying the policy.

An alternative way to provide extended coverage while reducing the adverse selection risk is to price the extended coverage retroactively. In this approach, the employer is given the pricing formula before buying the policy. Full enhanced coverage begins immediately, but the employer is charged after the fact, at the agreed pricing, for years in which the termination experience exceeds the base coverage and falls within the extended coverage.

In another approach for enhanced coverage, the employer does not specify a stop loss percentage but rather specifies in advance a coverage multiplier that applies to all of the cells. For example, if the multiplier is 2, then the enhanced coverage for a cell for which the HDR is 1.67% would be 3.33% in addition to the base coverage. Using the same multiplier of 2, the enhanced coverage for a cell for which the HDR is 2% would be 4% in addition to the base coverage. Under this approach, no vesting schedule of the enhanced coverage is used. Thus, the coverage is simpler to price and simpler to administer. In addition, the insurer does not undertake any credit risk as would happen in the approach that involves retroactive pricing.

The enhanced coverage for a cell may be carried over from year to year. For example, suppose an employer has paid for enhanced coverage using a multiplier of 2 and the HDR is 2% in a given cell. If the corporation experiences an actual displacement rate in that cell in the first year of 3%, then 3% of the enhanced coverage was not used in the first year and may be carried over to the second year, and so on.

The use of a multiplier ties the actual enhanced coverage directly to the HDR experience, which is theoretically, at least, a more appropriate way to define the coverage. The multiplier approach does not penalize a cell that has a high HDR, as would the stop loss approach. The pricing of the enhanced coverage can be computed in the same way as the pricing of the base coverage. In a simple case, for example, the price of the enhanced coverage could be a multiple of the price of the base coverage. Or the enhanced coverage price could be adjusted to reflect differences in the durational risk associated with the base coverage and the enhanced coverage.

The premium to be paid by the employer for the insurance policy is determined by adding cell premium amounts determined for each category of coverage (base and extended) of the employee benefit cells of that employer.

The premium amount is calculated by taking the gross salaries of all qualifying employees in a given cell or group of cells and multiplying that amount by a premium factor. The premium factor for a cell is calculated based on the benefit amounts and durations for that cell, the historical experience for that cell, the risk appetite of the insurer and or reinsurer (in terms of the portion of the durational risk elected by the insurer or reinsurer), net investment income allocable to that cell, broker commissions, fronting fees, overrides, premium taxes, carrier overhead, inter-employment support services, a deductible amount, if applicable, a stop loss percentage, if applicable, or a multiple, if applicable.

For example, if the historical base coverage experience of a given cell is 1.67% and the termination benefits extend for 26 weeks for that cell, the premium for that cell could be set based on 18 weeks so that the employer pays 18/26 of 1.67% of the average salary of all qualifying employees of the employer in that cell, for base coverage, net of unemployment insurance benefits received by the terminated employee.

A similar computation applies to the extended coverage with respect to the 3.33% (in the example discussed above) except that the numerator may be a higher number of weeks, say 20 weeks, to accommodate the fact that the duration of unemployment may be somewhat longer in aberrant or catastrophic termination scenarios than for the base risk.

By making the premium computation on a cell by cell basis, high salary cells will bear higher premium amounts for coverage that is limited as to those cells. This reduces the risk of adverse selection by an employer with respect to planned termination scenarios involving only high salary employees.

If the time it takes for an employee to become re-employed is the same as the benefits period (e.g., 26 weeks), the insurer would lose money because the premium only contemplates that benefits will last for a shorter period (e.g., 18 weeks). The result of the pricing approach is that the employer gets a reduction in his average annual termination expense. The insurer would undertake the risk (called a durational risk) that termination benefits will actually be greater than the premium. For example, assuming a 26 week benefit, the premium may only be based on 18 weeks. The insurer could also benefit from the upside of reemployment experience that is better than 18 weeks. The insurer, at its option, could choose to assume durational risks at different points in the 26 week period, for example, during the final two weeks.

In some implementations, the underwriter is a distinct entity from the party that manages and can benefit from the durational risk.

An example of an insurance policy that provides such benefits is attached as Appendix A and incorporated by reference.

Additional factors affect the coverage provisions of the policy and the pricing of the premium. The pricing model must take account of the tax rate on the premium, the fronting fee paid to the insurance entity, the expenses of administering claims, the fee to the claims administrator, overhead of the insuring entity including IP royalties, profit that is expected to be reaped on the premium by the insurer, costs of reinsurance, income from investments of funds, the government managed unemployment insurance benefits rates, the FICA and FUTA tax rates to the employer, the workmen's compensation premium rate of the employer, and the cost of outplacement services.

An employee who is placed in a new job and then either loses the job (for a non-causal reason) or elects to leave will return to the coverage pool for the remaining benefit period or until he is re-employed, but the period during which he was not being paid by the claims administrator represents potential profit to the claims administrator.

The pricing can be done using a model created as a Microsoft Excel spreadsheet. An example of a model that uses the inputs discussed above to generate a premium for the product is attached as Appendix B. Other kinds of software could be used to compute the insurance prices. The software could be run on any conventional personal computer or on any variety of other computer platforms. The software and all of the data needed for the pricing computations could be stored on a hard disk drive or other media.

As seen in FIG. 3, the insurance policy is sold by a broker 34 to an employer 30, which has qualified employees 32 who are covered by the termination benefits. Before the sale may be completed, the employer provides underwriting data 36 to an insuring entity 40 and the insuring entity 40 provides a price 38 (premium) to the employer. The underwriting data is loaded onto a storage medium in a computer controlled by the insuring entity and is used by the pricing model to generate the price. The insuring entity gives the broker authority 54 to use its name and make the sale on its behalf.

The insuring entity 40 will cause to be provided (in some cases through a separate entity or entities) a variety of services associated with the underwriting process. The services may include, for example, market research to identify and qualify prospects, to prepare preliminary sales calls and the presentations for such calls, and to assist and advise with the selection of variables and benefits. The insuring entity will also cause to be gathered (in some cases through a separate entity or entities) the historical data specific to the prospective customer; will cause the pricing to be developed, and will cause the underwriting decisions to be made The insuring entity may help with follow-up presentations including cost/service analyses. Once the underwriting decision is made, the insuring entity provides the policy and other documentation, activates the account, books claim liabilities, tracks amounts, frequency and duration of, and either directly or through the claims administrator pays claims, assists in causing retraining (when appropriate) and job search assistance to be provided, e.g., through a duration manager.

The underwriting data includes historical termination information about each cell of employees. The data also includes choices made by the employer that affect the computation of the price. The choices may include the weeks of benefits (e.g., 26 weeks) that will be given to employees in each of the cells, the percentage of salary which will define the benefits, a deductible amount for enhanced coverage, a stop loss percentage, if applicable, and an enhanced coverage multiplier, if applicable.

The underwriting data is stored in computer readable form on a storage medium and used on a computer as part of the pricing model. The insuring entity uses the underwriting data to generate the price based on subprices generated for each of the employee cells separately.

Once the price has been set and the employer agrees to buy the policy, a contract 50 (Appendix A) is provided by the insuring entity to the employer. In return, the employer pays an annual premium 52.

The insuring entity 40 can be structured in a wide variety of ways either within one company or by agreements among companies. In the example shown in FIG. 3, a lead insurer 56 issues the policy and receives the premium but then may cede portions of the risks and premiums to a reinsurer 60. Excesses 61 of premiums over benefits paid are invested by an investment manager 62. The insuring entity uses computer software to track the effectiveness of the investment manager.

The insurance policy provides base coverage and enhanced coverage (if the employer so chooses). The lead insurer retains the obligation to pay benefits on a percentage (e.g., 10%) of the base coverage, retains part of the premium as compensation for that risk, and receives a fronting fee of, say, 1% for its role in organizing the insurance entities.

The lead insurer cedes a percentage (e.g., 90%) of the base coverage risk and a percentage (e.g., 10%) of the enhanced risk obligation to the reinsurer and pays, e.g., 89% of the base premium and 10% of the enhanced premium to the reinsurer.

The insurer lends the use of its name (and implicitly its brand identification and reputation) to the product. The insurer uses an underwriting model, described below, to develop the prices based on the historical termination data for an employer. The lead insurer 56 licenses a claims administrator 68 to manage the payment of benefits and the delivery of placement services. The claims administrator could be part of the insuring entity. If not, the lead insurer also pays the claims administrator an administrative fee 102.

As seen in FIG. 4, during the policy period, claims management and benefit payments are handled by the claims administrator 68 while the durational risk is managed by a duration manager 680.When the employer 30 non-voluntarily terminates an employee 32, notice of displacement 33 and a copy of the appropriate employee file is sent from a computer 31 of the employer electronically to a computer 69 of the claims administrator.

Each time a payment is made, an invoice is automatically generated and passed from the administrator's computer 69 to the lead insurer's computer 57. Funds to cover the benefits are then returned electronically to the claims administrator. The reimbursement by the lead insurer of its percentage of the benefit obligations continues even after the employee returns to work. If that occurs earlier than the end of the benefit period, the subsequent reimbursement payments by the lead insurer may be kept for the account of the insurer or the duration manager. This gives the duration manager 680 a strong incentive to get each terminated employee re-employed at the earliest possible time.

Payments and services to the employee continue automatically until either the benefit period defined for that employee's cell ends, or the employee finds another job if that occurs sooner. If so, notice of the new employment is given to the claims administrator's computer from the computer 690 of the duration manager 680 and is passed along electronically to the insurer's computer as an instruction to cease benefits.

To obtain benefits, the employee must also promptly give a notice to activate service benefits 71 to the claims administrator 68. The notice to activate is matched in the computer 69 with the employee file that has already been received from the lead insurer, which initiates the steps required to provide the termination benefits. The computer 69 notifies the computer 690 of the notice to activate service benefits. Computer 690 is arranged to provide resume information, employment files, and notices 79 automatically to approved staffing agencies 70, which contact the employees through the duration manager and provide placement and other services aimed at helping each employee to find a new job, reporting each client contact to the duration manager. The duration manager may also provide assistance in placement.

The responsibilities of the duration manager include assigning an individual duration administrator to each terminated employee. The duration administrator has direct telephone contact with the terminated employee using a pre-scripted interview and develops a standard resume. A database search is done for possible matches with the employee's skills. Interviews may be scheduled. Training may be recommended and scheduled. Benefit payment authorizations are also reviewed and authorized.

Based on the day of termination, the employee cell to which the employee belongs, and the benefits to be provided (all of which are provided to computer 69 by the lead insurer), computer 69 automatically determines the dates and amounts of benefit payments to be made and mails checks to the employee. The amounts of the payments are reduced by the amounts of state unemployment benefits. Information 77 about those would have been initially loaded in computer 69 from as part of the original claim management software.

The main business strategy of the duration manager is to reduce the period of unemployment (displacement duration) so that it can maximize, as additional profit, the difference between the coverage payments received from the insuring entity and the benefit amounts paid to covered, terminated employees. To achieve this, the duration manager maintains strategic relationships with specialty staffing service firms and specialty training companies, which provide temporary, contract, and permanent placement of professional and technical employees and place a high value on retraining. The duration manager also will have access to information about the employment needs of other insureds, subscribers, or other databases.

Flow charts can be used to illustrate methods of the invention.

Referring to FIG. 5, determining a price 300 for a product includes the following sequence. Historical information is stored 302 about rates of termination of employees of the employer who are non-voluntarily terminated during a predetermined historical period. The information includes numbers of previously terminated and processed employees 304, salary histories 306, tenures 308, and job classifications 310. Historical information is also stored 311 indicating periods of time during which employees who are non-voluntarily terminated are expected to remain unemployed 311, including unemployment durations of terminated employees 312.

Limits of basic and enhanced coverage for each employee cell are established 314 using information provided by the insured.

The pricing process considers enhanced and basic coverages separately for each cell 316. An estimate is made 318 of the amount of money that will be required to pay termination benefits under the basic insurance product to employees who are non-voluntarily terminated, assuming a continuation of the historical termination rates.

The enhanced coverage can be priced based on the agreed stop loss amount 320 or on retroactive pricing or on the multiplier. The price determined to this point for each cell is then adjusted for expected inflation 322. The price for the insurance product is set to be smaller than the estimated amount of money 324 so that the employer's cost for termination benefits will be smaller under the insurance product than without the insurance product.

If the enhanced coverage portion of the product is not to be priced retroactively 326, then a price is set and a vesting schedule is created 328, except that no vesting schedule is required if the enhanced coverage is priced based on a multiplier. If the enhanced coverage portion of the product is to be priced retroactively, a pricing formula can be generated for each cell and a retroactive payment schedule can be set 330.

The process of payment of termination benefits 398 includes storing claims information 400 based on notifications of non-voluntary terminations; storing information about time limits of termination benefits for each cell 402, and storing displacement duration information 404; and validating employment status. Information useful in assisting terminated employees to find new jobs is generated 406. This is done based on information about employment qualifications 408, information for prescripted interviews 410, and available jobs.414. Dates of reemployment are tracked 416. Limits of termination benefits are compared with claims made, by cell 418. Limits implied by any vesting schedule are applied to enhanced benefits 419. Benefits may be withheld based on the employee's eligibility for state benefits 421. Termination benefits are paid 420 based on individual pay period benefit amounts 422, cumulative benefit amounts 424, and reemployment dates 426.

The insurer of the termination benefits need not withhold amounts under FICA (Federal Insurance Contributions Act), Federal Unemployment Tax Act (FUTA), State Unemployment Insurance (SUI), and Medicare from the amounts paid to the terminated employee, provided that the insurer operates in a form that takes advantage of United States federal tax provision 501(c)(17), a supplementary unemployment benefit (SUB) plan based on the principles set forth in Revenue Rulings such as Rev. Rul. 56-249, 1956-1 CB 498, Rev. Rul. 77-347, 1977-2 CB 362, Rev. Rul. 60-330, 1960-2 CB 46, Rev. Rul. 58-128, 1958-1 CB 89, Rev. Rul. 67-38, 1967-1 CB 9, Rev. Rul. 57-37, 1957-1 CB 18, Rev. Rul. 57-383, 1957-2 CB 44, Rev. Rul. 62-54, 1962-1 CB 285, Rev. Rul. 71-70, 1971-1 CB 27, and Private Letter Ruling 1995 WL 346854.)

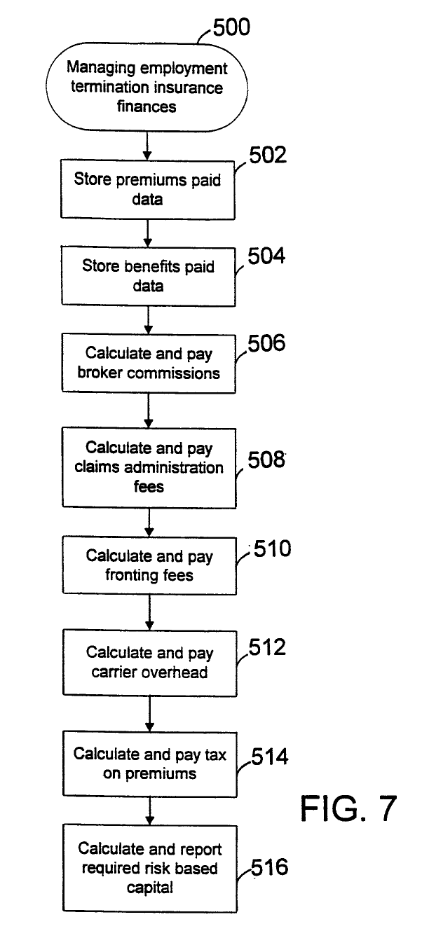

Referring to FIG. 7, the process for managing employment termination insurance finances 500 includes several steps. Data about premiums paid is stored 502 as is data about benefits paid 504. Broker commissions are calculated and paid 506 as are claims administration fees 508, fronting fees 510, carrier overhead 512, and taxes on premiums 514. Risk-based capital is also calculated and reported 516.

Other embodiments are also within the scope of the following claims.

For example, the coverages could be split explicitly into three parts, instead of bundling them into two coverages. The three coverages could be basic, aberrant, and catastrophic.

1. A method comprising
aggregating prices for coverages of termination benefits with respect to cells of employees who are selected, based on employment demographics, to reduce the impact of adverse selection by an employer of the employees,
the price for each of the cells including an enhanced component that represents an excess over an anticipated termination rate of that cell,
the excess termination rate being a predetermined multiple of the anticipated termination rate for at least some cells for which the anticipated termination rates are different.

2. The method of claim 1 in which the employment demographics comprise at least one of the employees' salaries, length of service, and job classification.

3. The method of claim 1 in which the anticipated termination rate is based on an historical displacement rate.

4. The method of claim 1 in which the multiple is selected by the employer.

5. The method of claim 1 in which the predetermined multiple is used to determine the excess termination rate with respect to all of the cells.

6. The method of claim 1 in which the price for each cell includes a base component that represents an anticipated termination reate of employees in the cell, and the base component and the enhanced component reflect different durational risks.

7. The method of claim 1 in which the excess termination rate represents coverages that are to be available for termination benefits in a single year.

8. A method comprising
receiving from an employer a designation of a predetermined multiple value associated with pricing of coverage for termination benefits for employees of the employer who are terminated in excess of anticipated termination rates, and
providing coverage for termination benefits in each of at least some cells of employees up to a rate that is the predetermined multiple value times the anticipated termination rate for the cell,
the cells comprising groups of employees selected, based on employment demographics, to reduce the impact of adverse selection by an employer of the employees,

9. The method of claim 8 in which the employment demographics comprise at least one of the employees' salaries, length of service, and job classification.

10. The method of claim 8 in which the anticipated termination rate is based on an historical displacement rate.

11. The method of claim 8 in which the predetermined multiple value used to determine the excess termination rate with respect to all of the cells.

12. A method comprising
(a) paying termination benefits to employees who belong to cells based on employment demographics, the termination benefits for employees in each of the cells being limited to a number of employees that represents an historical displacement rate for that cell plus a predetermined multiple of the historical displacement, and
(b) declining payment of further termination benefits for at least some of the cells when the paid termination benefits reach the level specified in (a).
